(19) United States
(12) Patent Application Publication
(10) Pub. No.: US 2014/0345110 A1
(43) Pub. Date: Nov. 27, 2014

(54) ANCHOR SYSTEM, IN PARTICULAR UNDERCUT ANCHOR SYSTEM

(71) Applicant: HILTI AKTIENGESELLSCHAFT, Schaan (LI)

(72) Inventors: Peer Schmidt, Lindau (DE); Joerg Appl, Buchs (CH); Serhey Khandozhko, Buchs SG (CH)

(21) Appl. No.: 14/375,992

(22) PCT Filed: Jan. 22, 2013
(86) PCT No.: PCT/EP2013/051112

§ 371 Date: Jul. 31, 2014

(30) Foreign Application Priority Data
Jan. 31, 2012 (DE) 102012201293.1

(51) Int. Cl. F16B 29/00

(52) U.S. Cl. CPC F16B 29/00
USPC 29/450; 411/21

(57) ABSTRACT

In an anchor system, for example, an undercut anchor system, having an anchor bolt with an expansion element, preferably at least one engagement means for the purpose of bearing a load, an expansion sleeve surrounding the anchor bolt, a means for detecting an axial end position of the expansion sleeve on the expansion element when the expansion sleeve is expanded and moved axially, the axial end position of the expansion sleeve should be able to be detected precisely. This problem is solved in that the means has a sensor for the purpose of detecting the axial end position.

The present invention relates to an anchor system, particularly a deformation controlled expansion anchor system, for example an undercut anchor system, according to the preamble of Claim 1, and a method for the fastening of an undercut anchor system according to the preamble of Claim 11.

Undercut anchors having an anchor bolt with an expansion element and engagement means, as well as an expansion sleeve surrounding the anchor bolt, serve the purpose of fastening components to a construction or stonework. For this purpose, a bore hole is made in the construction—for example a concrete wall or a concrete ceiling, and then the undercut anchor is inserted into the bore hole.

Following the insertion of the undercut anchor into the bore hole, the expansion sleeve is made to rotate using a setting tool, and an axial pressure is additionally applied to the expansion sleeve in the direction of the expansion element As a result of the axial pressure, the expansion sleeve is opened at the end of the expansion sleeve, at the position of the expansion element This means that the expansion sleeve is pushed outward radially, and additionally the material of the components is removed and/or milled out by means of the rotational movements of the expansion sleeve. As a result, it is possible to create an undercut in the material of the component by means of the expanded sleeve, and thereby to produce a positive-fitting connection between the expanded sleeve and the material of the component. Due to the expansion of the expansion sleeve, the expansion sleeve leads to an axial movement in the direction of the expansion element relative to the anchor bolt. In the process, the expansion sleeve is only permitted to move a prespecified distance and/or a prespecified length in the direction of the expansion element, up to an axial end position. For this purpose, the anchor bolt has a marking which is covered poor to the insertion and expansion of the expansion sleeve. When the expansion sleeve is inserted in the direction of the expansion element, this marking becomes visible at the axial end position, and can therefore be seen by the user. Once this marking is visible, the setting process of the undercut anchor must be halted. This means that the setting tool must be switched off, and no more axial pressure can be applied to the expansion sleeve. If the expansion sleeve is inserted too far axially, there are negative effects on the bearing capacity and the ability of the undercut anchor to hold. For this reason, when the undercut anchor is set, it is absolutely necessary that the user precisely monitors the arrival of the anchor in the axial end position, which requires great effort. This means that a check must constantly be made until the marking is visible when the expansion sleeve is inserted axially.

DE 37 31 819 A1 shows art expansion anchor and/or undercut anchor having an anchor bolt, wherein a conical extension is connected to the cylindrical shaft thereof in the direction in which the same is set, and the shaft bears engagement means on the end therefore which is opposite this extension. The anchor bolt is surrounded by an expansion sleeve which is able to move relative to the anchor bolt and which is at least partially, longitudinally slotted proceeding from the end where the setting is initiated. The inner diameter of said expansion sleeve corresponds to the outer diameter of the shaft, and the expansion sleeve has a peripheral cutting tooth on the end thereof which is the front in the direction of setting.

The problem addressed by the present invention is that of providing an anchor system, for example an undercut anchor system, and a method for fastening an undercut anchor system, wherein it is possible to precisely and reliably detect an axial end position of the expansion sleeve.

This problem is addressed by an anchor system, by way of example an undercut anchor system, having an anchor bolt with an expansion element, preferably at least one engagement means on the anchor bolt or on the expansion sleeve for the purpose of bearing a load, an expansion sleeve which surrounds the anchor bolt, a means for detecting an axial end position of the expansion sleeve on the expansion element when the expansion sleeve is expanded and moved axially, wherein the means has a sensor to detect the axial end position. It is advantageous that there is no longer a need to visually monitor the reaching of the axial end position during the setting Of the anchor, and particularly the undercut anchor, using the eyes of the user. Rather, the axial end position can be detected by the sensor. As a result, it is possible to detect the axial end position in a particularly precise manner, and a particularly secure and reliable setting of the anchor is possible.

The anchor system is preferably an undercut anchor system, and particularly a self-cutting undercut anchor system—that is, a system wherein the anchor itself can produce an undercut in the bore hole. However, the system can also be a non-self-cutting undercut anchor system, wherein the anchor is inserted into a bore hole which has already been drilled with an undercut. Essentially, the invention can include all deformation-controlled expanding anchors. Accordingly, the anchor system can also be a strike anchor system.

In one additional embodiment, the sensor is an optical, magnetic, mechanical, inductive, or capacitive sensor, and/or the means comprises a processor, for example a microcontroller, and/or a data storage device. The data detected by the sensor or by a device for reading an identification device can be processed by means of the processor, and can be saved by means of the data storage device—for example for being read out later or for the purpose of monitoring setting procedures of different anchors.

In one complementary variant, a sensor element is arranged on the anchor bolt, and can be detected by the sensor.

In one additional embodiment, the sensor element is a marking or a code, in the case of an optical sensor, is a permanent magnet in the case of a magnetic sensor, is a mechanically detectable geometric element such as a recess, for example, in the case of a mechanical sensor, or is a plate of a capacitor in the case of a capacitive sensor. If the sensor element is a marking or a code, this marking or the code can only be detected by the optical sensor if the marking or the code on the anchor bolt is not covered by the anchor sleeve. By way of example, in the case of a permanent magnet, the distance to the permanent magnet is detected by the sensor, and if this is below a prespecified distance to the permanent magnet, the axial end position has been reached—particularly if the sensor is arranged or constructed on the setting tool.

In an additional embodiment, the anchor system comprises a sensor device, and the means is arranged on a separate sensor device. The sensor device is an additional, particularly easily portable component supplementary to the anchor, by means of which it is possible for the user to monitor and check the axial end position independently of the setting tool. For this purpose, the sensor device preferably also has an energy storage device—for example a battery—for the purpose of operating the sensors, and preferably the processor and the data storage device in the sensor device.

In an additional variant, the anchor system comprises a setting tool, and the means is arranged on the setting tool. As a result, no additional component, such as a sensor device, is necessary, and the means are integrated into the setting tool. In particular, the setting tool in this case can be designed in such a manner that the setting tool is automatically and/or independently switched off when the axial end position is reached, and thereby it is not possible for the expansion sleeve to move axially beyond the axial end position.

In an additional embodiment, an anchor, particularly an undercut anchor, comprises the anchor bolt and the expansion sleeve, and the anchor, particularly the anchor bolt or the expansion sleeve, has an identification device—for example a barcode or an RFID chip. By means of the identification device, it is possible for different anchors to be identified, and it is thereby possible to save the data pertaining to the accordingly identified anchor, detected by the sensor by means of the setting tool or the sensor device. This makes it possible to accordingly record the setting procedure, and thereby to optionally render unnecessary an approval of the setting procedure of the anchor, by an inspector. A worker and/or user can electronically save the setting procedure during the setting procedure such that it is thereby possible to demonstrate the reliable and secure setting of the set anchor, all the way to the axial end position, based on this saved data.

In a complementary embodiment, the sensor device or the setting tool having the means of a device for reading the identification device. Prior to the setting of the anchor, the identification device is generally read by means of the device. The device is, in the case of a barcode, an optical sensor, for example, and—in the case of an RPM chip—an RFID transponder.

The expansion sleeve is advantageously expanded by means of an axial movement of the expansion sleeve relative to the expansion element, due to a conical geometry of the expansion element, and/or the material in the bore hole can be removed by means of the expanded expansion sleeve as the result of a rotary movement of the expansion sleeve. If the anchor system is an undercut anchor system, the axial movement of the expansion sleeve relative to the expansion element is preferably achieved by the expansion sleeve being slid over the axially-fixed expansion element. If the anchor system is a strike anchor system, the axial movement of the expansion sleeve relative to the expansion element can preferably be achieved by the anchor bolt with the expansion element being driven deeper into the axially fixed expansion sleeve. In the case of an undercut anchor system, the engagement means used to fasten a component is advantageously formed by a threading worked into the anchor bolt—particularly an external threading. In contrast, in a strike anchor system, the engagement means used to attach a component are preferably brined by a threading worked into the expansion sleeve—particularly an internal threading.

In a complementary embodiment, the anchor bolt and/or the expansion element and/or the at least one engagement means consists at: least particularly, and particularly completely, of metal—for example steel—and/or a method described in this patent rights application can be carried out by means of the anchor system.

A method according to the invention for fastening an undercut anchor system, particularly an undercut anchor system described in this patent tights application, having the steps: insertion of an undercut anchor into a bore hole, connection of the undercut anchor to a setting tool, application of a torque to an expansion sleeve using the setting tool, such that the expansion sleeve is made to rotate, application of an axial pressure to the expansion sleeve such that the expansion sleeve is moved axially in the direction of the expansion element and the expansion sleeve is expanded by the expansion element, halting of the axial movement and the rotary movement of the expansion sleeve once a prespecified axial end position of the expansion sleeve. relative to an anchor bolt has been reached, wherein the axial end position is detected by a sensor.

A sensor element on the anchor bolt is particularly detected by means of the sensor, particularly optically, magnetically, mechanically, inductively, or capacitively, and/or the sensor is operated with electric current.

In a complementary variant, the construction is removed in the bore hole by means of the expanded, rotating expansion sleeve, and as a result an undercut is made in the construction.

A positive-fit connection is advantageously created between the expanded expansion sleeve and/or the expansion element, on the one hand, and the construction in the undercut on the other hand.

In a complementary variant, the sensor has a functional connection with the setting tool, and once the prespecified axial end position of the expansion sleeve relative to the anchor bolt is reached, as detected by the sensor, the setting tool is automatically switched off. Therefore, during the setting procedure and the insertion of the expansion sleeve, the setting tool is automatically switched off when the axial end position is reached, such that no more material in the construction can be further removed as a result, and thereby a further axial movement of the expansion sleeve relative to the anchor bolt is prevented. As a result, a movement of the expansion sleeve beyond the axial end position is prevented, such that errors resulting from the expansion sleeve being inserted too far are substantially prevented during the setting of the undercut anchor.

In a complementary variant, an identification device—for example a barcode or an RFID chip—on an undercut anchor is read by a device, and the data detected by the sensor is evaluated according to the data read.

The data detected by the sensor, particularly the data pertaining to the prespecified axial end position for the undercut anchor identified by means of the identification device, is advantageously saved in a data storage device in a sensor device or in the setting tool, for example. The data detected by the sensor, particularly pertaining to the axial end position, can be saved in the data storage device, and particularly in such a manner that the same is assigned to a corresponding undercut anchor according to the assignment made by the identification device. In this way, the secure setting of the undercut anchor by a user can be electronically recorded by means of the setting tool or the sensor device.

In a further embodiment, the at least one engagement means has a threading on the anchor bolt, and/or a washer and/or a nut.

In particular, the at least one engagement means is constructed on a second end of the anchor bolt.

In a further embodiment, the anchor bolt and the expansion sleeve are oriented coaxially to each other.

In a complementary variant, the axis of rotation of the rotary movement of the expansion sleeve corresponds to a longitudinal axis of the anchor bolt.

Embodiments of the invention are described below in greater detail with reference to the attached drawings, wherein:

FIG. 1 shows a longitudinal cross-section of an undercut anchor;

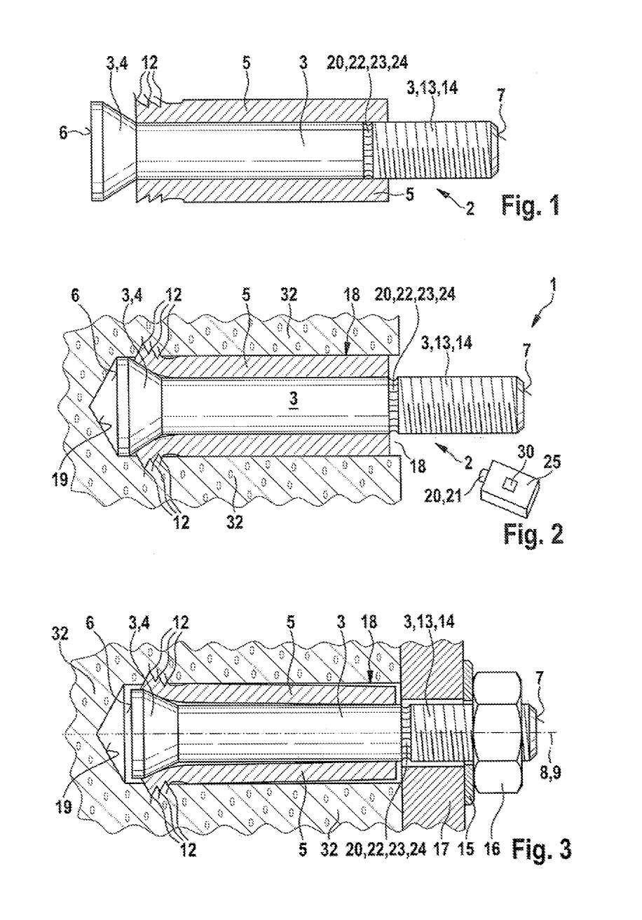

FIG. 2 shows the undercut anchor according to FIG. 1 following the insertion thereof into a bore hole, and following the expansion of the expansion sleeve;

FIG. 3 shows the undercut anchor according to FIG. 1 following the fastening of a component;

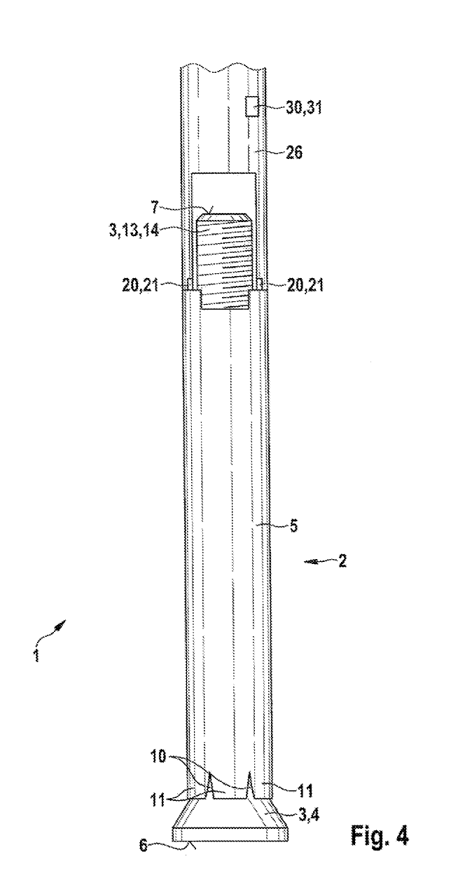

FIG. 4 shows the undercut anchor according to FIG. 1 with a setting tool prior to the insertion into a bore hole;

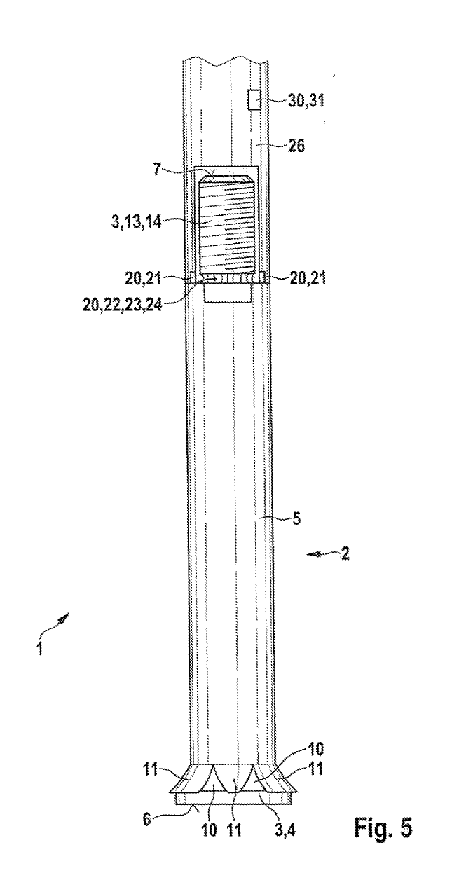

FIG. 5 shows the undercut anchor according to FIG. 1 following the expansion of the expansion sleeve by means of the setting tool; and

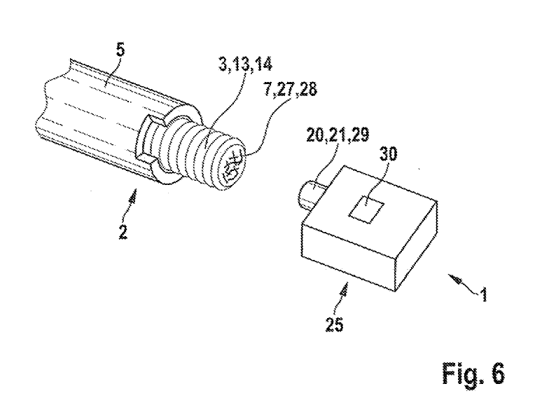

FIG. 6 shows a partial perspective view of the undercut anchor and of a sensor device.

An undercut anchor 2 illustrated in FIGS. 1 to 6 serves the purpose of fastening a component 17 to a construction 32. A bore hole 18 and/or bore 18 is made in the construction 32, and the undercut anchor 1 is inserted into this bore hole 18 for the purpose of fastening the component 17. The construction 32 is a concrete wall or a concrete ceiling of a building, by way of example.

The undercut anchor 1 has an anchor bolt 3. The anchor bolt 3 has a first end 6 and a second end 7. When the undercut anchor 2 is inserted into a bore hole 18, of a construction 32, the first end 5 is inserted into the bore hole 18, and a second end 7 of the anchor bolt 3 remains outside of the bore hole 18 (FIG. 2). A conical expansion element 4 is constructed on the first end 6 as a single piece together with the anchor bolt 3. An expansion sleeve 5 is arranged on the anchor bolt 3 coaxially to and surrounding the same 3. The expansion sleeve 5 has longitudinal slots 10 in the direction of a longitudinal axis 9 of the anchor bolt 3, in the first end 6 of the anchor bolt 3, such that the expansion sleeve 5 has expansion segments 11 (FIGS. 4 and 5) as a result of the axial longitudinal slot 10.

Three engagement means 13 are arranged on the second end 7 of the anchor bolt 3 for the purpose of fastening the component 17 following the fastening of the undercut anchor 2 in the bore hole 18. The engagement means 13 are a threading 14 worked into the anchor bolt 3, a washer 15, and a nut 16. The nut 16 has an inner threading, which is not illustrated, which engages with the outer threading 14 on the anchor bolt 3.

To set the undercut anchor 2, first a bore hole 18 is made in the construction 32 to a precisely prespecified length, by means of a drill. Next, the bore hole 18 is generally cleaned by means of pressurized air, and the undercut anchor 2 illustrated in FIG. 1 is inserted into the bore hole 18 (FIG. 2). Next, the expansion sleeve is made to execute a rotary movement about an axis of rotation 8 by means of a setting tool 26, which is only partially illustrated in FIGS. 4 and 5, wherein the axis of rotation 8 corresponds to the longitudinal axis 9 of the anchor bolt 3 and the expansion sleeve 5. In addition, a pressure is applied to the expansion sleeve 5 or to the conical expansion element 4 in the direction of a bore hole base 19. As a result, of this axial pressure, the expansion sleeve 5 is expanded in the region of the expansion element 4—that is, it is deformed radially outward. The expansion sleeve 5 has multiple longitudinal slots 10 such that separate expansion segments 11 are expanded. In addition, the expansion segments 11 have cutting teeth 12 (only illustrated in FIG. 1 to FIG. 3). As a result of the rotary movement of the expansion sleeve 5, the cutting teeth 12 and/or the expansion segments 11 are able to work into the material of the construction 32 and wear away the same, such that an undercut is formed in the construction 32 around the cutting teeth 12 and the expansion segments 11, thereby forming a positive-fit connection between the expansion sleeve 5 and the material of the construction 32. The expansion sleeve 5 in this case is only permitted to be moved a prespecified distance and/or a prespecified length axially relative to the anchor bolt 3 when being set. For this purpose, the anchor bolt 3 has a code 24 and/or a marking 23 as a sensor element 22, which also forms the means 20. Prior to the insertion of the undercut anchor 2 into the bore hole 18, these markings 23 are covered by the expansion sleeve 5. The markings 23 are therefore not visible. The markings 23 are only visible once the expansion sleeve 5 is moved axially relative to the anchor bolt 3.

A sensor device 25 (FIG. 2 and FIG. 6), as a portable component, has as battery for the purpose of supplying the same with power, a processor for the purpose of processing data, and a data storage device. In addition, the sensor device 25 has an optical sensor 21 as the means 20 for detecting the axial end position of the expansion sleeve 5. If the making 23 is entirely outside of the expansion sleeve 5, the expansion sleeve 5 is at its axial end position. This axial end position can be detected by means of the optical sensor 21, and then a signal is output by means of a display device 30, for example an optical and/or acoustic display device 30. By way of example, a red blinking light and an acoustic tone, as a beep, is emitted by the display device 30. During the setting procedure using the setting tool 26, it is therefore possible to very precisely detect the axial end position of the expansion sleeve 5 by means of the sensor device 25. Once the axial end position is reached, the setting tool 26 must be switched of by the user—meaning that the rotary movement of the expansion sleeve 5 is halted, and also no more axial pressure is permitted to be exerted on the expansion sleeve 5. The setting process of the undercut anchor 2 is therefore ended and completed per regulation. In this process, the undercut anchor 2 forms an undercut anchor system 1 together with the sensor device 25.

After the setting procedure is complete, a component being fastened to the anchor bolt 3 by means of the nut 16 and the washer 15 can be fastened. In this process, due to the axial tensile force applied to the anchor bolt 3, the expansion element 4 moves slightly away from the bore hole base 19 (FIG. 3), and the expansion element 4 braces in the milled-out undercut in the construction 32, together with the expanded expansion sleeve 5 and/or the expansion segments 11. As a result, a very secure and reliable positive-fit connection is formed between the undercut anchor 2 and the construction 32.

A second embodiment of the undercut anchor system 1 is illustrated in FIGS. 4 and 5. Below, only the differences with respect to the undercut anchor system 1 in the first embodiment, in FIG. 2, will be substantially described. The optical sensor 21 and the display device 30 are not integrated or assembled with a separate sensor device 25. Rather, they are installed in the setting tool 26. In this case, a functional connection is formed between the means 20 for detecting the axial end position—meaning the optical sensor 21, the processor, and the data storage device. Once the axial end position is reached, the setting tool 26 is automatically switched off. As a result, it is possible to advantageously avoid an error during the setting procedure in which the expansion sleeve 5 would be inserted beyond the axial end position in a manner which is not permitted. Once the setting tool 26 is switched off, the rotary movement of the expansion sleeve 5 is ended, and the expansion sleeve 5 can thereby substantially be prevented from moving or being pushed any further axially in the direction of the bore hole base 19, because the material of the construction 32 can no longer be milled away. The setting tool 26 further comprises a communication device 31 for the transmission of data. If different types of undercut anchors 2 are being set by means of the setting tool 26, the data detected by means of the optical sensor 21 can not only be saved in the setting tool 26, but also the same can be transmitted to and stored by other electronic devices—such as a laptop computer, by way of example—by means of the communication device 31. Such a communication device 31 can also comprise the sensor device 25 with the same functionality.

An additional embodiment of the undercut anchor 2 is illustrated in FIG. 6. The undercut anchor 2 has an identification device 27 on the second end 7, designed as a barcode 28. The undercut anchor 2 and/or the type of the undercut anchor 2 can be detected and stored in the sensor device 25 by means of the barcode 28 and by means of a device 29 for reading the barcode 28 and/or the identification device 27. In this case, the device 29 for reading the identification device 27 is also simultaneously the optical sensor 21. In contrast, the optical sensor 21 and the device 29 can also be separate elements (not illustrated). In an analogous manner to the sensor device 25 illustrated in FIG. 6, the setting tool 26 can also comprise the device 29, and the functionality of the sensor device 25 described below can also be executed by the setting tool 26.

Prior to the undercut anchor 2 being set, the type of the undercut anchor 2 and/or the undercut anchor 2 is detected by means of the device 29, and then the setting procedure is stored in the data storage device of the sensor device 25. This means that the data concerning the identified undercut anchor 2, detected by the optical sensor 21, is saved. In this way, a setting procedure can be recorded, and also the fact that the axial end position has been reached can accordingly be recorded, in electronic form. Moreover, the corresponding data for different undercut anchors 2 or different types of undercut anchors 2, with respect to the axial end position thereof, can be saved in the data storage device, and it is thereby possible for the data detected by the optical sensor 21 to be compared to the saved data in the data storage device in order to achieve an optimum calculation and detection of the axial end position of the undercut anchor 2. The stored data pertaining to the many and/or differing undercut anchors 2 which are set by means of the setting tool 26 can be read out by means of the communication device 31. In this way, the correct observance of the axial end position for a plurality of set undercut anchors 2 can be saved following the completion of the setting procedure in the construction 32, and is therefore electronically recorded.

In sum, substantial advantages are associated with the undercut anchor system 1 according to the invention and the method for fastening the undercut anchor system 1 according to the invention. An optical sensor 21 detects the axial end position of the expansion sleeve 5 when the undercut anchor 2 is set and/or fastened in as bore hole 18 in the construction 32. In this way, it is advantageously possible to prevent errors in a manual reading performed by the user. In addition, not only is a more precise detection of the axial end position possible, but also the setting tool 26 can be automatically switched off when the axial end position is reached, and the detected data pertaining to the axial end position being correctly reached can be saved in a data storage device, and thereby later accordingly saved on other devices—for example a laptop computer—by means of a communication device, for the purpose of record-keeping.

1-15. (canceled)

16. An anchor system, comprising:
an expansion anchor comprising,
an anchor bolt;
an expansion sleeve surrounding the anchor bolt;
an expansion member carried by the anchor bolt and being configured to expand the expansion sleeve in response to axial and rotational movement of the anchor bolt relative to the expansion sleeve; and
an engagement mechanism formed on at least one of the anchor bolt and the expansion sleeve, the anchor mechanism being configured to bear a load and facilitate axial movement of the anchor bolt relative to the expansion sleeve; and
a sensor device configured to determine when a predetermined axial end position of the expansion sleeve relative to the anchor bolt has been reached during expansion of the expansion sleeve.

17. An anchor system according to claim 16, wherein the sensor is one of an optical, magnetic, mechanical, inductive, or capacitive sensor.

18. An anchor system according to claim 17, further comprising a sensor element arranged on the anchor bolt which registers with the sensor.

19. An anchor system according to claim 18, wherein the sensor element arranged on the anchor bolt comprises a marking, a code, a mechanically detectable geometric element or a capacitive plate.

20. An anchor system according to claim 19, wherein the anchor system has a setting tool, and the sensor device is carried by the setting tool.

21. An anchor system according to claim 16, wherein the anchor bolt further comprises an identification device that includes identification data.

22. An anchor system according to claim 21, wherein at least one of the sensor device and the setting tool includes a device for reading the identification device.

23. An anchor system according to claim 16, wherein the expansion element comprises a conical geometry configured to expand the expansion sleeve when the expansion member is moved axially relative to the expansion sleeve.

24. A method for fastening an undercut anchor, comprising the steps:
inserting an undercut anchor into a bore hole;
connecting the undercut anchor to a setting tool;
applying torque to an expansion sleeve using the setting tool, such that the expansion sleeve is made to rotate;
applying axial pressure to the expansion sleeve such that the expansion sleeve is moved axially in the direction of the expansion element and the expansion sleeve is expanded by the expansion element;
halting of the axial movement and the rotary movement of the expansion sleeve once a prespecified axial end position of the expansion sleeve relative to an anchor bolt has been reached;
wherein the axial end position is detected using a sensor device.

25. A method according to claim 24, wherein the senor device is configured to detect a sensor element carried by the anchor bolt.

26. A method according to claim 25, wherein the sensor device comprises one of an optical, magnetic, mechanical, inductive or capacitive sensor device, and where the sensor device is operated with electrical current.

27. A method according to claim 26, wherein the sensor device is coupled to the setting tool, and wherein the setting tool is automatically switched off once sensor device detects that the prespecified axial end position of the expansion sleeve relative to an anchor bolt has been reached.

28. A method according to o claim 27, further comprising using a sensor to read identification data from an identification device carried by the anchor.

29. A method according to claim 28, further comprising determining the prespecified axial end position based on the identification data.
